(19) United States
(12) Patent Application Publication
(10) Pub. No.: US 2002/0147607 A1
(43) Pub. Date: Oct. 10, 2002

(54) Automated INS application filing system

(76) Inventors: Sarvajit Thakur, Saratoga, CA (US); Cesare Alessandrini, Saratoga, CA (US); Thameem Kamaldeen, Saratoga, CA (US)

Correspondence Address: Ray K. Shahani, Esq., ATTORNEY AT LAW, Twin Oaks Office Plaza, 477 Ninth Avenue, Suite 112, San Mateo, CA, 94402-1854, US

(21) Appl. No.: 10/050,245

(22) Filed: Jan. 15, 2002

Related U.S. Application Data
(60) Provisional application No. 60/269,221, filed on Feb. 14, 2001.

(51) Int. Cl. G06F 17/60

(52) U.S. Cl. 705/1

(57) ABSTRACT

A method for processing immigration applications electronically, and enabling users such as prospective or recent immigrants to start, manage, and complete the immigration and associated processes on-line.

### RELATED INVENTIONS

This Application is related to and incorporates herein by reference, in its entirety, U.S. Provisional Application Serial No. 60/269,221 filed Feb. 14, 2001 entitled SYSTEM AND METHOD FOR AN INTERACTIVE INS APPLICATION FILING AND FEED-BACK INFORMATION, and claims any and all benefits to which it is entitled therefrom.

### FIELD OF THE INVENTION

This invention generally relates to a method for processing immigration applications and other INS filings electronically, and for enabling prospective and recent users, including immigrants, to start, manage, and complete the required immigration and associated processes online.

### BACKGROUND OF THE INVENTION

There are various types of applications immigrants file with the different immigration related agencies and organizations in different countries. Not all applications get the full attention of the professionally trained community. Unfortunately, immigrants involved with such types of applications are often helpless. In lucky cases when help is available, the immigrant is in no position to afford it.

Generally, each immigration application comprises of one to multiple Immigration and Naturalization Services, or INS, forms being integrated with the required supporting documents, such as birth certificate, copies of passport, etc., to make it complete. The INS is an agency of the federal government of the United States which is charged with regulating and controlling the immigration and naturalization processes which relate to the U.S.

The process for the INS applications usually begins with an application which comprises a core INS form specific to that application. The applicant will have to initially satisfy certain requirements for filling up this form. Then, the applicant is assisted by a legal professional, and fills out this core form. Based upon the individual, particular circumstances of the applicant, the applicant is prompted to fill-out other INS forms that may be required to be integrated with this core form. For certain information provided by the applicant in each of these INS forms, he/she is required to authenticate the same by submitting supporting documents.

Then the applicant, with the help of the legal professional, double checks the information that he has provided on the INS forms. Based on the instructions accompanying the forms he has filled out, he attaches the relevant supporting documents. Thus his application to the INS is complete. As a final step based on the instructions in INS forms, he is required to submit the completed application at the relevant INS office.

Currently legal professionals handhold the applicants through this process starting with determining their eligibility to file the application, providing the necessary forms, assistance in filling up the forms and submitting the completed application at the INS office. This can be a very costly process and the applicant may have to make multiple visits with an appropriate lawyer.

As such, it can be seen that a need exists for an automates system to help individuals to start and complete this process on their own.

Forms are used throughout the world in all types of regulated systems. Typically and traditionally, forms have been filled out by hand or typewriter. These have included securities and regulatory filings, tax filings, business filings, commercial forms including invoices, etc. With the advent of the personal computer, many forms are now filled out electronically and then printed. Forms can be reproduced on the monitor of a computer and a data entry function adds the particular data to the forms. The data can be entered manually or merged from a data source or file. When the form is complete, the form can be printed and saved.

Recently the advent of form wizards has made filling out of forms a less cumbersome task. In a typical form wizard, the graphical user interface shows a menu which prompts a user to enter data. As the user enters data, the form wizard prompts the user for additional, particular information based upon the previously entered data. The U.S. Patent and Trademark Office utilizes an electronic filing system for the filing of trademark registration applications on-line entitled Trademark Electronic Application System, or TEAS. This system allows the user to enter data and a trademark application is filled out and filed electronically. The system has an option to print out the completed application form which can be filed in hard form as well. TurboTax (R), a popular personal taxes filing software application also incorporates various form wizards into its products. Again, these products allow individual tax filers to enter appropriate data into the system, and the system produces an electronic form or forms which can be printed and mailed or which can be filed electronically.

### SUMMARY AND ADVANTAGES

A method for processing immigration applications electronically, and enabling users such as prospective or recent immigrants to start, manage, and complete the immigration and associated processes on-line.

This automated INS application filing system of the present invention, hereinafter simply “System”, is the first and only system that allows users, such as potential, prospective and recent immigrants and related parties and communities to start, manage, and complete the immigration and associated processes on-line on their own. Apart from the several man-years of domain knowledge put forth by the lawyers and experts, the system will incorporates the best technologies and a dedicated technical team to bring this extremely useful solution to the community.

The System provides a set of highly user friendly and interactive “Do-it-Yourself” (DIY) tools and supporting systems that seamlessly guide the user through the entire process of completing, filing and tracking the different immigration and related applications, on-line.

The System will not only enable the user to complete his application but also provides the means to interact with all the related agencies involved, on-line. Apart from the above stated activities, it also provides the user a virtual workplace to carry out all their immigration related activities on-line. Those activities include: electronic storage of all types of documents, including scanned, hand or typed filled out, etc, circulation and sharing of these documents with various organizations, agencies, or individuals involved.

The approach of this invention is along the current practice. Applicants choose the particular or specific application they need to file. Tutorial guidance comes in the form of an interactive application that intuitively leads the applicants through the application process, right from the eligibility to completion of the application. The system acts as a form wizard in certain respects but has enhanced capability and function not found in standard form wizards.

After the applicant chooses the application he is planning to apply, he is then directed to the specific module at the website. The applicant is then taken through an eligibility test (usually test is based on the core form, specific to that application) that determines whether he is qualified to apply. The eligibility also aids in determining other supporting INS forms that may have to be integrated with the core form. Once he qualifies, he is taken to the next step.

The next step is to fill out the core form and the supporting forms. The actual form is not displayed to the applicant. He/she will be prompted some sets of relevant questions. Based on his answers to these, the form gets automatically filled out. Those answers are also used by the System to prompt other supporting INS forms and to modify the instructions that need to be provided to the applicant.

Upon completion of the simple questions, the applicant is taken to the print preview page. There he/she will be allowed to view the forms completed with his information. If they want to review any information in any section of the form, they are allowed to trace back to the set of questions pertaining to that section or questions directly pertaining to the erroneous information, observe and change their answers.

Once the applicants are satisfied with the answers, they are given the option to either go ahead and print the form or to save the completed form and to start filling out the other supporting INS forms through the same procedure of simple questions and print preview.

Thus the applicants print out the INS forms as they complete each one of them or take the printout of all the forms (that are part of his application) at the end. Each of these forms is accompanied by their instructions. The instructions provided with each form, enable the applicants to complete any other details required, list supporting documents with that specific INS form, and INS office location where they are to currently send the completed application either by postal mail or deliver it personally.

One object and advantage of the present invention is to provide a more convenient method of getting through the process of INS application and giving the applicant control over the entire process.

Another object and advantage of the present invention is to provide a less expensive and more affordable method of INS application filing process.

A further object and advantage of the present invention is to save time for the applicants as the applications will be submitted to the related agencies on-line.

A further object and advantage of the present invention is to reduce the time and complexity of a conventional application or request processing through the INS by eliminating unnecessary filings, providing complete, accurate forms with the necessary accompanying documents and fees, if any required, along with instructions on how to file, when to appear, what to bring to appointments and associated and necessary travel and amenities instructions and information.

A further object and advantage of the present invention is to add a layer of security to the INS system by obtaining a clear record and track of users of the INS system, along with all of the associated data they provide during any of the various modules of the present invention, including eligibility quiz, form data processing, payment modules, etc., along with the capability to screen potential applicants and proceedings and, if necessary, implement regulatory, police or military security operations.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1. is a key indicator for the subsequent flow charts describing the elements of the System of the present invention.

FIG. 2 is the tree overview of the nomenclature adopted to classify the various sections and sub-sections of a preferred embodiment of the present invention core system.

FIG. 3 is an overview flow chart of a preferred embodiment of the present invention core system and its multiple interfaces with sub-systems.

FIG. 4 is a flow chart of a preferred embodiment of the present invention that diagrams the flow of user information in the core system.

FIG. 5 is a flow chart overview of a preferred embodiment of the Automated INS application filing system of the present invention and its connection with other agencies.

FIG. 6 is a flow chart design overview of a preferred embodiment of the present invention core system.

FIG. 7 is a flow chart overview of a preferred embodiment of the home page section of the present invention.

FIG. 8 is a diagram describing a preferred embodiment of a section linked to the home page of the present invention describing the usefulness of the present invention.

FIG. 9 is a diagram describing a preferred embodiment of a section linked to the home page of the present invention providing visa information.

FIG. 10 is a diagram describing a preferred embodiment of a section linked to the home page of the present invention describing the system and corporate overview.

FIG. 11 is a diagram describing a preferred embodiment of the press page linked to the home page of the present invention containing a history of all press releases.

FIG. 12 is a diagram describing a preferred embodiment of another section linked to the home page of the present invention listing frequently asked questions.

FIG. 13 is a diagram describing a preferred embodiment of the User Log-in section linked to the home page of the present invention.

FIG. 14 is a flow chart describing a preferred embodiment of the Official INS Form as a module linked to the home page of the present invention.

FIG. 15 is a flow chart describing a preferred embodiment of the INS application status page linked to the home page of the present invention.

FIG. 16 is a flow chart describing a preferred embodiment of the “Begin Application” section linked to the home page of the present invention.

FIG. 17 is a flow chart overview of a preferred embodiment of the module home page interfacing with several other sections of the present invention.

FIG. 18 is a flow chart of a preferred embodiment of the eligibility requirement module interfacing with the home page module of the present invention.

FIG. 19 is a flow chart of a preferred embodiment of the module for documents needed to start an application interfacing with the home page module of the present invention.

FIG. 20 is a flow chart of a preferred embodiment of the process module interfacing with the home page module of the present invention.

FIG. 21 is a flow chart of a preferred embodiment of the module for frequently asked questions interfacing with the home page module of the present invention.

FIG. 22 is a flow chart of a preferred embodiment of the module for eligibility quiz section interfacing with the home page module of the present invention.

FIG. 23 is a flow chart of a preferred embodiment of the module for simple questions interfacing with the home page module of the present invention.

FIG. 24 is a flow chart of a preferred embodiment of the preview section module interfacing with the home page module of the present invention.

FIG. 25 is a flow chart of a preferred embodiment of the print section module interfacing with the home page module of the present invention.

FIG. 26 is a flow chart of a preferred embodiment of the sign-up section interfacing with the home page module of the present invention.

FIG. 27 is a flow chart of a preferred embodiment of the disclaimer section interfacing with the home page module of the present invention.

FIG. 28 is a flow chart of a preferred embodiment of the payment section interfacing with the home page module of the present invention.

FIG. 29 is a flow chart of a preferred embodiment of the Adobe Acrobat® (download module interfacing with the home page module of the present invention.

FIG. 30 is a flow chart of a preferred embodiment of the demo section for the Adobe Acrobat® (download module interfacing with the home page module of the present invention.

FIG. 31 is a flow chart of a preferred embodiment of the multi-lingual interface (subsystem) of the present invention.

FIG. 32 is a flow chart of a preferred embodiment of the lawyer consultation interface (sub-system) of the present invention

FIG. 33 is a flow chart of a preferred embodiment of the e-filing interface (sub-system) of the present invention.

FIG. 34 is a flow chart of a preferred embodiment of the e-signature interface (sub-system) of the present invention.

FIG. 35 is a flow chart of a preferred embodiment of the documents processing equipments interface (sub-system) of the present invention.

FIG. 36 is a flow chart of a preferred embodiment of the information exchange interface (sub-system) of the present invention.

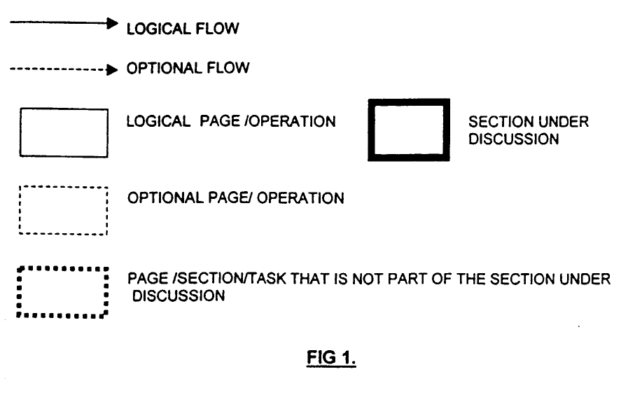

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

It is an object of this invention to help the consumers to start, manage and complete immigration and related processes online on their own. The business model and the entire supporting website design through which the automated INS application filing system guides users to complete and coordinate their immigration and related applications on the website is described here by classifying the operations into various sub-systems. The design and functional requirements of the core system and each of its supporting subsystems is described. The process documentation has been done taking one module (immigration application) into consideration. The same flow can be repeated for any new module that is added to the automated INS filing system.

Even though the document at certain points in the process draws analogy with the US immigration process for purpose of better understanding, this can be adopted as a universal process for all immigration and related applications throughout the world.

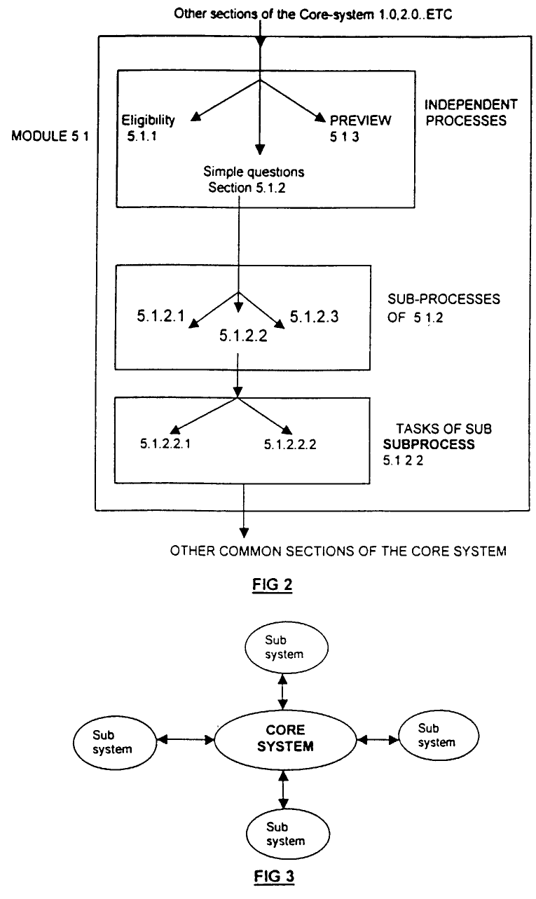

FIG. 2 is the tree overview of the nomenclature adopted to classify the various sections and sub-sections of a preferred embodiment of the present invention core system. Here, the entire site is represented as one core system supported by other sub-systems to make up the entire automated INS application filing system. The INS Experts (TM) core system has several common sections which will encompass each one the application modules to make the application processing core system complete to the user.

A “MODULE” is an immigration application, that has been broadly classified in the scope and named generically in this document as 5.1, 5.2 5.n etc. Each module actually addresses the flow in any specific immigration application type, e.g.: INS applications such as I-90 application module, Naturalization, H1B Visa module etc.

Each application is a functional area that consists of independent processes such as Eligibility and simple questions. The independent processes for a module 5.1 are numbered as 5.1.1, 5.1.2., etc. These independent processes were divided into discrete sub processes and tasks which put together form this independent process. The sub process for an independent process 5.1.2 will be numbered as 5.1.2.1. Any further tasks under this sub-process 5.1.2.1 will be numbered 5.1.2.1.1. Actual operations are derived from these sub processes and tasks.

For example, an H1-B application (A Process) may require 5 INS forms to be filled up. Each form is a sub-process which requires to be filled out and arranged with its required supporting documents. All MODULES are supported by the same common sections in the system to make the logical flow complete.

Core System of the Automated Ins Application Filing System

The System will ask simple questions to help applicant for a Do It Yourself (hereinafter DIY) approach to prepare their forms step-by-step and to store them in the System for future access (via User ID and Password). Over 100 immigration forms will be directly accessible by users which they can fill out and print by paying a fee (via credit card or other means). Through the system the user will also be able to liaison and work with any of the entities that may be related to his application.

The System approach is along the current practice. In the CORE system the guidance comes in the form of an interactive application that intuitively leads the applicant through the application process, right from the eligibility to completion of the application. The core system will offer the following services in each module to the users, to enable them complete the application:

Step 1: User chooses the application he/she is planning to apply. The applicant is directed to the specific module at the website.

Step 2: At this module, the applicant is taken through an Eligibility test (usually test is based on the core form, specific to that application) that determines whether he/she is qualified to apply. The eligibility also aids in determining other supporting INS forms that may have to be integrated with the core form. Once they qualify, they are taken to the next step.

Step 3: The next step is to fill out the core form and the supporting forms. The actual form is not displayed to the applicant. He will be prompted some sets of relevant questions. Based on his answers to these, the form gets automatically filled out. His answers are also used by the System to prompt other supporting INS forms and to modify the instructions that need to be provided to the applicant. (The Instructions are specific to this core form. It provides details to be completed on the printed application and lists all the supporting to be submitted with this form.)

Step 4: Upon completion of the simple questions, he is taken to the print preview page. Here he will be allowed to view the forms completed with his information. If he wants to review any information in any section of the form, he is allowed to trace back to the set of questions pertaining to that section and re-look/change his answers.

Step 5: Once he is satisfied with the answers, he is given the option to:

a) Go ahead and print the form. The Instructions specific to that form will also be part of the printout, or

b) Save the completed form and start filling up the other supporting INS forms through the same procedure of simple questions and print preview.

Step 6: Thus the applicant prints out the INS forms as he completes each one of them or takes the printout of all the forms (that are part of his application) at the end. Each of these forms are accompanied by their instructions.

Steps 7: The instructions provided with each form, enable him to:

a) Complete any other details required E.g. Signature, date, etc.

b) List supporting documents with that specific INS form. E.g.: Photographs, Certificates, other testimonials.

c) INS office Location where he is to currently completed application either by postal mail or personally.

As per the instructions, the applicant can thus compile the filled up INS forms and their related supporting documents and submit his completed INS application to the INS.

Role of the Supporting Sub-Systems

The core system enables the users to complete and compile their applications. The supporting systems come into play to provide the user added value and more functions, such as:

The multilingual interface can help user all over the world to feel at home in the site.

Scanning Interface enables the users to scan and store their supporting/related documents for coordination/On-line filing.

The digital e-signature interface can help users incorporate digital e-signatures into their applications.

The lawyer interface will allow users to liaison with the profit and non profit legal community regarding their work and vice-versa.

The e-filing interface will enable user to submit their applications/documents electronically with the respective authorities.

The interfaces with the various agencies will allow the user to co-ordinate and exchange information with all associated organizations and authorities.

Context Diagram & Flow of User Information in the Core System

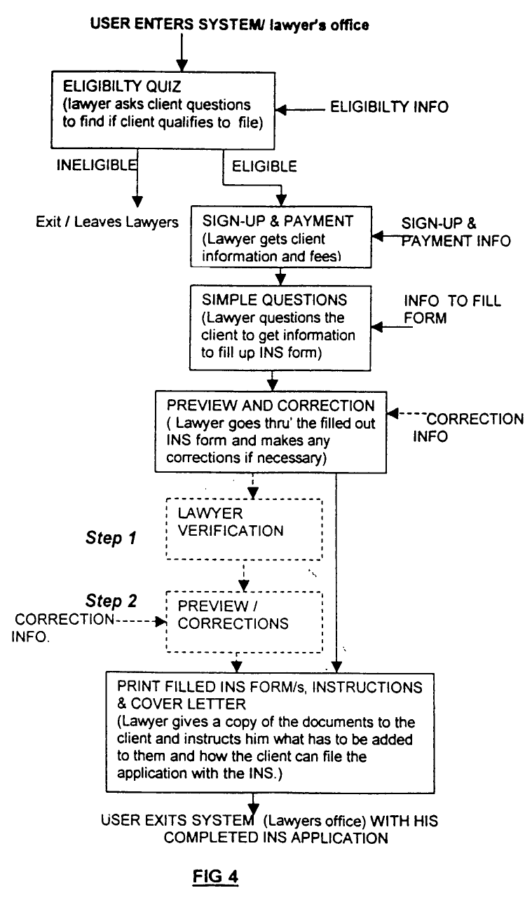

FIG. 4 is a flow chart of a preferred embodiment of the present invention that diagrams the flow of user information in the core system. Here, user enters the System (lawyers office) and the lawyer asks client questions to find out whether client qualifies to file).

If the user is eligible, then the user is prompted to a sign-up and payment site (where lawyer gets client information and fees). Then the user is asked some simple questions (where lawyer questions the client to get information to fill out INS form).

Then the user is asked to preview and correct the information (lawyer goes through the filled out INS form and makes any corrections if necessary).

Then there are two optional steps that include lawyer verification, and then preview and corrections. These services are available to the users who pay-up to use a lawyer to verify their completed application ON-LINE. This operation is part of the System and the lawyer will log-in into the System and verify the user application after he has filled it out.

The user then is prompted to print the filled out form/s, instructions and cover letter (lawyer gives a copy of the documents to the client and instructs him what has to be added to them and how the client can file the application with the INS). The user can then exit the System (lawyer's office) with his completed INS application.

Overview of the Automated Ins Application Filing System

FIG. 5 is a flow chart overview of a preferred embodiment of the automated INS application filing system of the present invention. This diagram shows the interfaces between multiple sources that are involved in operating this System. The core system in the chosen language interfaces with other sub-systems such as e-signature interface, document processing equipments interface, information exchange interface, e-filing interface, lawyer consultations interface, multi-lingual interface, as well as other users, immigration related professionals, government or other agencies.

Design Overview of the Core Sub-System

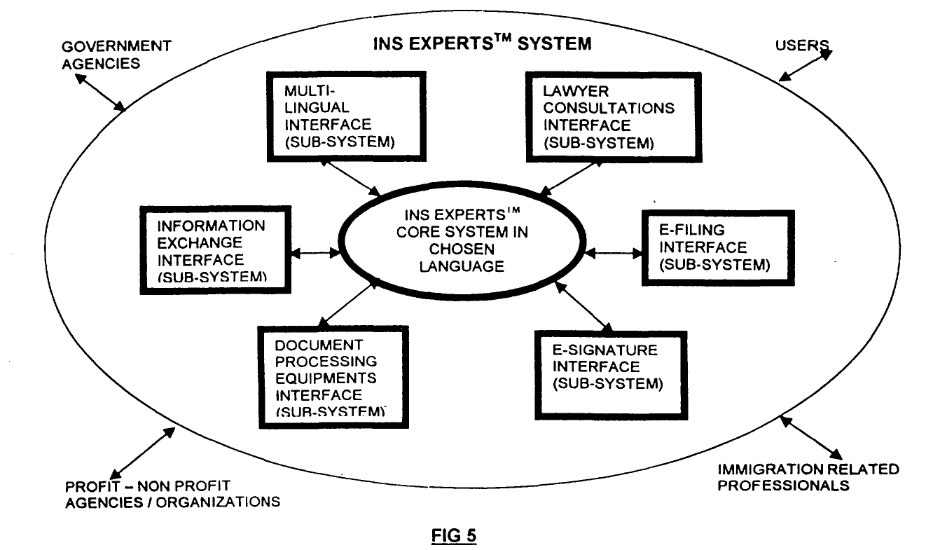

FIG. 6 is a flow chart design overview of a preferred embodiment of the present invention core system in relation with the different MODULES.

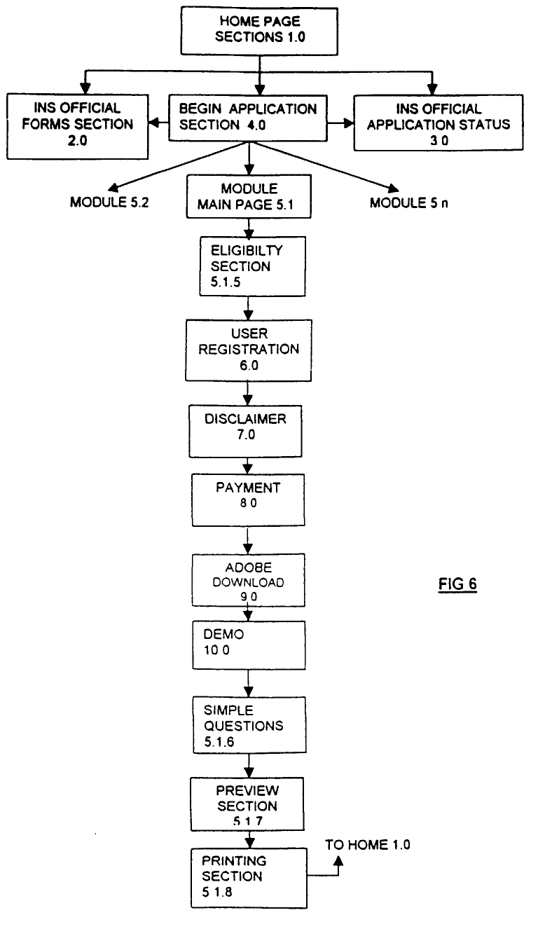

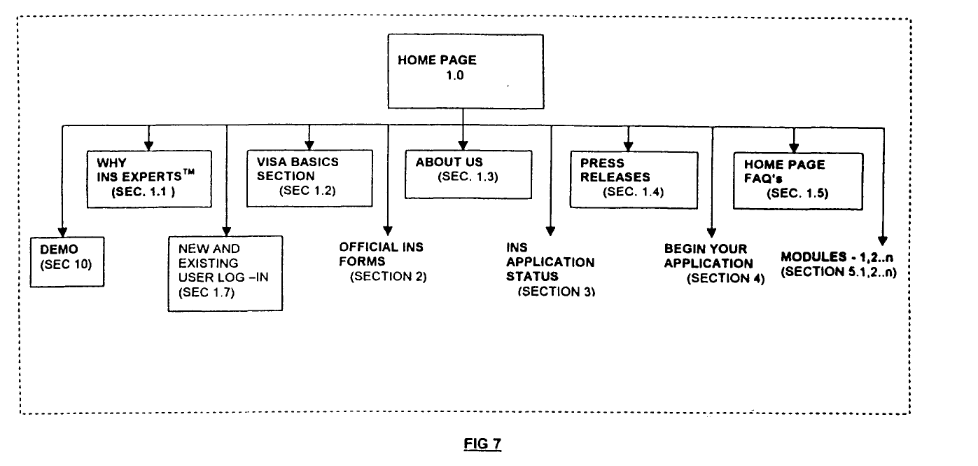

FIG. 7 is a flow chart describing a preferred embodiment of the functional specification of the home page 700 section of the present invention. The home page 700 includes various MODULES such as “Why INS Experts (TM)” 702, “Visa Basics Section” 704, “About Us” 706, “Press Releases” 708, and home page “Frequently Asked Questions” 710.

FIG. 8 is a diagram describing a preferred embodiment of an informational section 802, linked to the home page 800 describing the usefulness of the present invention. This link from the home page is a content section. The content explains the usefulness and merits of the System to the user and the users can then continue on to begin the application process or to go back to the home page.

FIG. 9 is a diagram describing a preferred embodiment of a section linked to the home page of the present invention providing visa information. This link from the home page 900 is a content section giving a brief overall explanation about US immigration, classifications of the immigration applications and the agencies involved. Visa Basics page 902 helps the user to select a topic of interest. Based on the topic chosen, a page 904 opens up with the information relevant to his topic. From page 904 or 906 the user can go back to the select topic page 902. The select topics page 902 has “back” button to the home page 900.

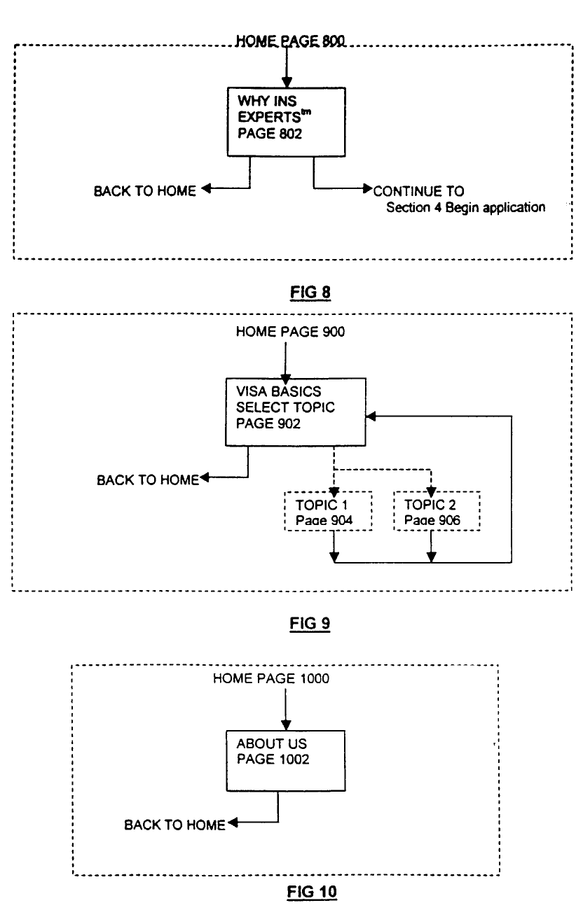

FIG. 10 is a diagram describing a preferred embodiment of a section linked to the home page 1000 of the present invention describing the system and corporate overview named About Us 1002. This page 1002 is a content page from the home page 1000. The contents give the corporate overview, the system objectives, the problem it solves and the market it addresses. The user can retrace back to the home page 1000 from this page.

FIG. 11 is a diagram describing a preferred embodiment of Press page 1100 linked to the home page 1108 containing a history of all press releases. This page will have history of all related news articles and press releases. In addition, it will contain Logo in PDF format. The selected press releases 1102, the selected news article 1104, and logos 1106 will be displayed based on resolution chosen. The user will be able to go “Back” to the home page 1108 or can choose any of the press release pages 1102, 1104, or 1106.

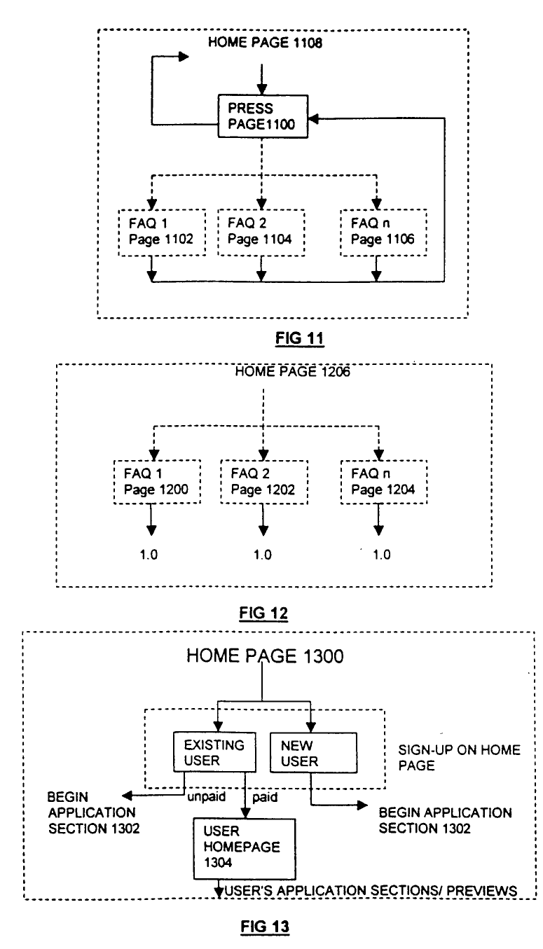

FIG. 12 is a diagram describing a preferred embodiment of another page linked to the home page listing frequently asked questions. These are links that answer the FAQs present on the home page 1206. These FAQ's are generic and address queries that the user may have related to the general INS application filing system. When the user clicks on an FAQ on the home page 1206, he is led to the page 1200, 1202, or 1204 that answers this FAQ. Once the user is satisfied he can return to the home page 1206.

FIG. 13 is a diagram describing a preferred embodiment of the User Log-in section linked to the home page. This section 1300 helps existing users access their application and for new users to sign-up and begin an application at the website. When a new user logs in, he is taken to the BEGIN APPLICATION SECTION 1302.

When an existing user, who has used the System previously and has paid for services, logs-in he is taken to the specific “USER's HOMEPAGE ”1304. This page contains the list of applications the user had signed up for. By clicking on any of them, he will be taken to that application preview or to the point where he exited from that application during the earlier session. When an existing user, who has still not paid up for any of system services, such as those provided by INS Experts (TM) logs-in he is taken to the “Begin Application” Section 1300.

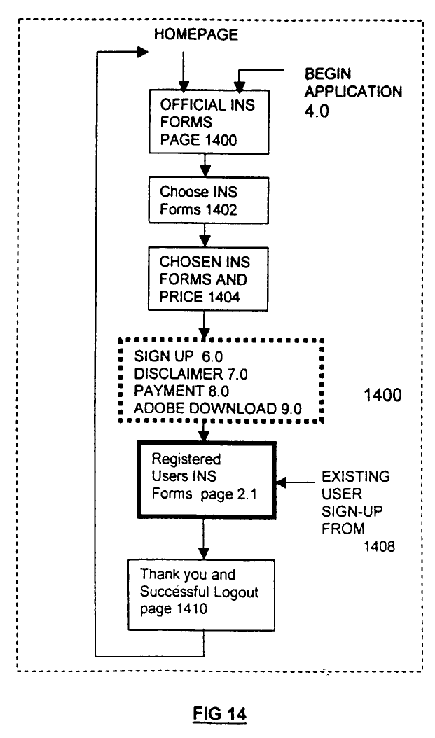

FIG. 14 is a flow chart describing a preferred embodiment of the Official INS Form as a module linked to the home page. The “Official INS Forms” page 1400 will be a module where users will be able to choose any INS forms for filling. Selected forms will then be displayed and users will be able to type information directly onto clearly defined areas in the form so they can print it. All information will be stored and info can be modified at a later point in time. Login and password will be given to each user once registered.

First user is informed about product and services at the first page 1400, then user will select INS forms which he/she would like to fill out 1402. User is then given a recap about all the INS forms chosen and cost of them 1404. At the next step, user will type in user ID and password, as well as, credit card information 1406. User will then be able to begin filling in form, make corrections etc. Once user is registered they will be able to reach this page by entering ID and password 1408 where the user is informed that all changes and information that has been entered is stored and also thanks the user 1410.

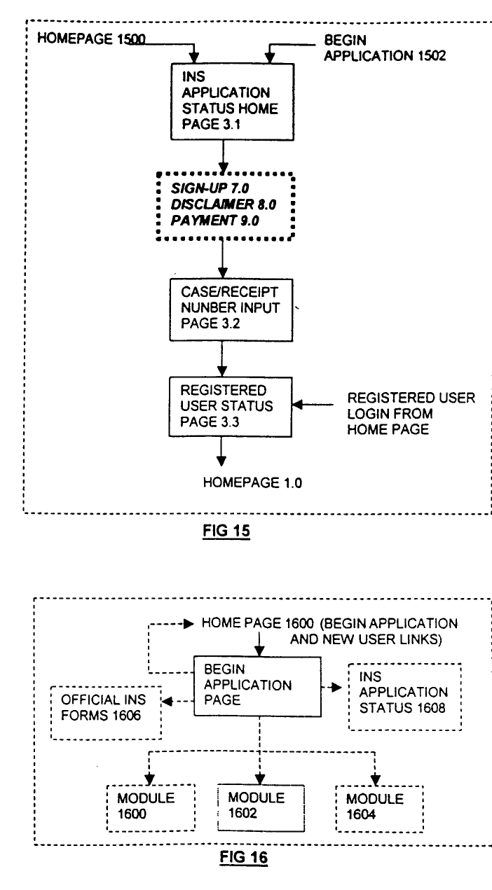

FIG. 15 is a flow chart describing a preferred embodiment of the INS application status page linked to the home page. The System collects the case numbers of their filed INS applications from the users who sign-up for this service, and it will then get a status for them directly from the INS and will post this information on the site for the users to access it by logging in. The System will also send an e-mail to the registered user on his/her status. New users will be able to access this either from the home page 1500 or by choosing this option on the “Begin Application” section 1502. Registered users can access their status by logging into their “user status” page from the home page.

Page 1504 gives an introduction and explains this service to the user. On page 1506 the user reaches this page after going through the Sign-up, Disclaimer and Payment Sections. The newly registered user enters his Case/receipt number on this page. A new page 1508 is generated for each specific user, where he sees the status of his application. The status for newly registered users will be updated within a few days of their sign-up. The registered users will be directly brought to this page when they log-in from the home page. After getting their status the users can logout to the Home page.

FIG. 16 is a flow chart describing a preferred embodiment of the “Begin Application” section linked to the home page. This page is to help the user decide on the type of application he wants to start at the INS application filing system. It has a list of the various products that the System offers. From this page, the user is taken to one of the application modules 1600, 1602, 1604 that he chooses. Links to other product sections such as Official INS forms 1606 and INS application status 1608 are also provided. Part from the home page 1610, there are several pages from where the user is directed to this page. However the logical flow would be from the home page.

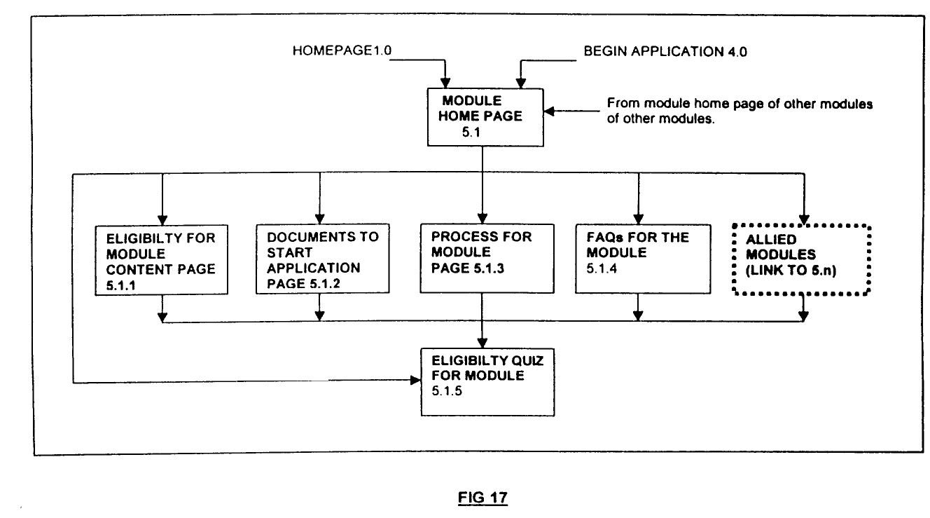

FIG. 17 is a flow chart overview of a preferred embodiment of the module home page interfacing with several other sections of the present invention. The module home page 5.1 (the 1 denotes the 1^{st} module) can be accessed either from the system such as INS Experts (TM) Homepage 1.0 or from the Begin application section 4.0. This page contains the introductory content to the module and the pricing information for the various applications within that module. Apart from the links that are explained below, there are also Direct links to the eligibility quiz section of this module section 5.1.5, and other allied modules. An Allied module 5.n is usually an entirely separate modules onto itself that still has some kind of connection to this module, e.g., Naturalization is module 5.1 and Replacement of Naturalization Certificate module 5.n. There still is a logical connection between both.

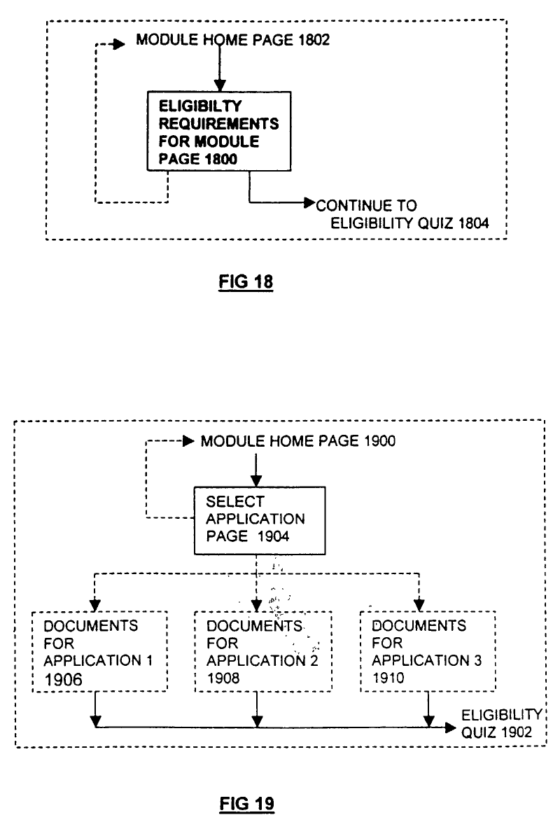

FIG. 18 is a flow chart of a preferred embodiment of the eligibility requirement module interfacing with the home page module. The content of this module 1800 explains the requirements that may have to be met by the user if he wished to apply for that application. This page has a “back” button to the module home page 1802 and a “continue” button to Eligibility section 1804 of that module.

FIG. 19 is a flow chart of a preferred embodiment of the module for documents needed to start an application. This section is a link from the home page. Each module can have different types of INS applications under them. (E.g. In the Naturalization & US Citizenship module, there can be either an N-400 or N-600 or N-643 application). When an applicant registers and starts answering simple questions pertaining to an application, he may have to provide information that is present in some of his documents. The purpose of section 5.1.2 is to provide the list of documents that the user needs to have with him in order to start filling up his application. This ensures that the user is not stranded for lack of information availability mid-way due to the proper document not being present. Once the user has been informed of the documents, he can proceed to the Eligibility Quiz section 1902.

This is a link from the module home page. The purpose of this page 1904 is to allow the user to select the application which he plans to apply for in that module. Based on the application he chooses, he is brought to page 1906 to 1908 to 1910. Pages 1906, 1908, and 1910 are pages that list the documents needed to start applications 1, 2 and 3 respectively. The user can continue to the eligibility section 1902 of the module from either of these pages.

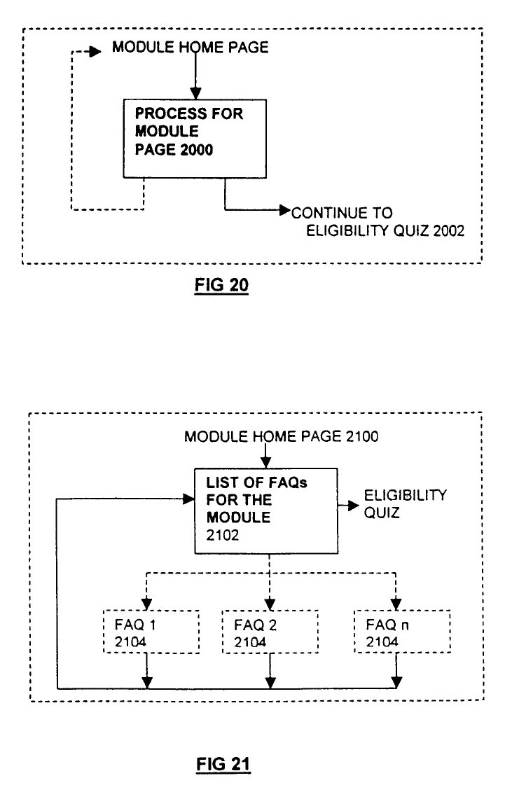

FIG. 20 is a flow chart of a preferred embodiment of the eligibility requirements for process module. The content explains the entire process involved in the various applications in module 2000. From this page, user has the option of either moving on to the Eligibility Quiz 2002 or back to the module home page 2000.

FIG. 21 is a flow chart of a preferred embodiment of the module for frequently asked questions. This page is a link from the module homepage 2100 which contains a list of the FAQ's relevant to that module. When the user click on an FAQ on this page 2102, he is led to a page 2104 that answers this FAQ. These are links that answer the FAQs present on the home page. Once the user is satisfied, he can return to the FAQ LIST 2102 page.

FIG. 22 is a flow chart of a preferred embodiment of the module for eligibility quiz section. The eligibility quiz section for a specific application determines if the user is “eligible” to apply for that particular INS application. The quiz, which is a set of easy to understand questions, has been designed taking nearly all the INS rules, the requirement criterion and the various scenarios for that application into consideration. The System is intelligent to prompt the relevant successive question based on the user's answers to a specific question. The user is taken through a seamless flow of questions at the end of which the system is able to decide whether the user is eligible to apply. If they are, they will be able to continue to the sign-up.

The process start with user beginning the “Eligibility Quiz” 2200. The user reaches this page from the eligibility content page 2202 or home page 2204. Please note that the user will be given the option to “Skip” the Eligibility Quiz and go directly to sign-up page 2206. In these pages users are asked specific questions which form the eligibility quiz. Anywhere from 10-25 different questions (different screens one after another) will be displayed depending on users previous answers. Two types of questions will be asked in this section: “Yes/No” and “Choose one” type of questions. FAQs 2208 may be available alongside some of the Quiz question pages to aid possible user queries. The end of the quiz will simply indicate to user that he/she is “Eligible” 2210 and can continue with the application process or is “ineligible” 2212 to continue further with the application process. (If despite his ineligibility, as per the System quiz, if the user still wants to go ahead and file his application; he will be able to do so. One of the ways will be to skip the quiz and go to the sign-up 2206 directly.)

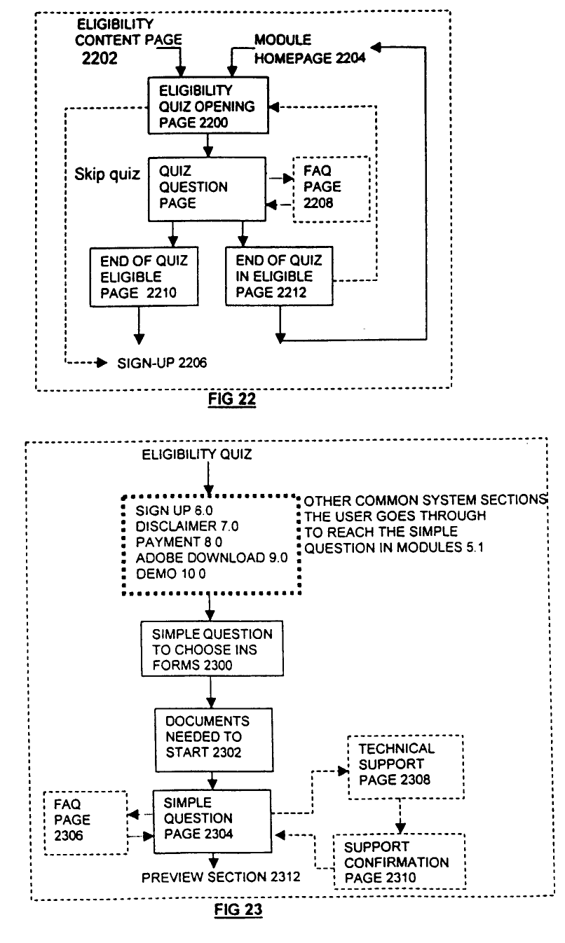

FIG. 23 is a flow chart of a preferred embodiment of the module for simple questions section. In this section the user is asked the easy to understand simple question to gather information so that the System can fill out his INS forms automatically. Each question relates to a field on the actual INS form. However the sequence of the questions may not necessarily be in accordance with the actual INS form. The simple questions are arranged in a manner to make a better logical sequence. By the end of the simple questions the system has collected enough information to fill out the users INS form.

Simple question section has also gathered information to generate a set of important instructions specific to this user. The instructions contain the list of supporting documents that the user needs to attach to his application. It also provides step-by-step instructions on how the user has to proceed until he actually files the completed application with INS. The generation of these instructions is transparent to the user.

The process starts when the user is asked a few questions that will determine which core INS forms and supporting INS forms that he may have to fill out. The user is brought to this page 2300 after the demo pages he walks after sign-up. From here will be taken to the first simple question pertaining to his core INS form.

The user is then brought to the next page 2302 as soon as the system has identified the forms the user needs on the previous page 2300. This page 2302 provides the user with a list of documents. The user should have these documents in order to provides information from them as he goes through the simple questions section.

In the next page 2304, the users are asked specific simple questions to collect information for filling out the INS form. As the user answers the simple question's, the system is intelligent to determine and provide only the questions that may collect information relevant for that user. This way the user fills in only the wanted information as may be required of his specific case. The user is given the option of saving his work that he has done till then and exiting the system. He can log-in and resume from where he left at any later point.

FAQs 2306 may be available alongside some of the Simple question pages to aid and clarify possible user queries.

Each simple question page 2308 has a support button If the user encounters any technical difficulties he can click on the support button. He is brought to the support page 2308. This page by default will contain the user ID, the simple questions page from which this support page was invoked and a message box. The user can type out the problem he is facing in the text box. When completed he clicks on the send button provided. Thus a mail on the reported problem is sent to the System support team. The user is taken to a support confirmation page.

The support confirmation page 2310 informs the user that his support message has been successfully sent. This page also provides him with the button to return back to the simple questions section. At the end of the simple questions the user is taken to the preview section 2312.

FIG. 24 is a flow chart of a preferred embodiment of the preview section module. Once the user completes the simple questions he is brought to the preview section 2312. In this section the populated actual INS form is displayed to the user. The form has been populated with information collected from the user in the simple questions section 2400. The purpose of the preview is to provide the user an opportunity to review the information that he has provided. The preview section also provides the means to the user to modify his information 2402. This page contains screen shots of the actual preview page and explains how the user can use the preview. It clearly explains the use of different options and functions on the actual preview page.

The actual preview page 2404 is segregated into two clear parts, one to the right that contains the Actual populated INS form in PDF format. The one to the left that contains the bookmarks of the various sections in the INS form. The user can scroll through and review his information on the populated INS form using the scroll bar along side the form. Alternatively, the user can directly go to and view any section of the form by clicking on that section's book mark on the right hand side of the screen. If the user discovers any improper information on the form which he needs to modify, he will not be allowed to change it on the PDF form directly. To modify information in any of the fields in a specific section, he will have to click on the “modify” button that has been provided underneath the bookmark of that section. He will be taken to the simple question that corresponds to the beginning of this section. The user can go through the simple questions in the section and change his answers and modify incorrect information. At the end of the simple questions pertaining to this section, the user is brought back to the preview page. Now the populated PDF INS form will reflect the changes that the user made. Thus the user can do similar iterations back and forth to ensure that all information is there to his satisfaction. Once he is completed with the preview and he is ready to print, he is taken to the print section 2406.

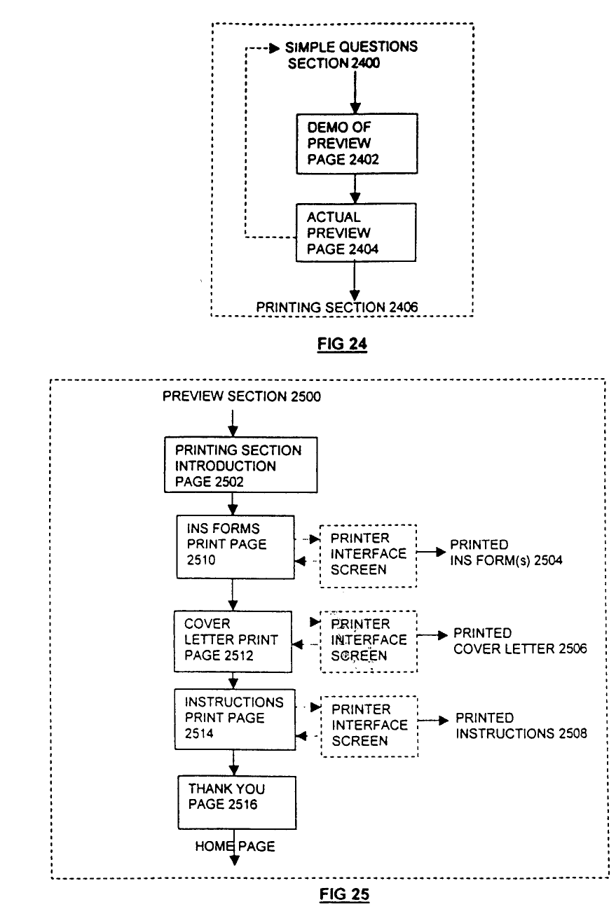

FIG. 25 is a flow chart of a preferred embodiment of the print section module. After a successful preview section 2500, user is brought to the print section. In this section, the user prints out the various components of his INS application.

The introduction page 2502 gives an over view of the print sections. It lists the printouts the user will get at the end of this section. It also informs him on the different steps involved in the user's application printing process. Viz. Step: Printing the filled out INS form(s) 2504, Step 2: Printing the Cover Letter for the INS application 2506, and Step 3: Printing the instructions 2508. This also keeps the user informed on what may have to be kept ready to enable the completion of the print.

The page associated with the first step of printing viz 2510 prints the filled out INS form(s). This page tells the user what he is going to print out. It also tells him what he will have to look for in the print out. This page has a print button that will enable the user to initiate the actual printing. It contains a back button that take the user to the introduction page 2502 and a continue that takes him to the next step of printing.

The next page 2512 is associated with the second step of printing viz. Printing the Cover Letter for the INS application. This page tells the user what the cover letter is and its use. This page has a print button that will enable the user to initiate the actual printing. It contains a back button that take the user to the previous page 2510, and a continue that takes him to the next step of printing.

The instruction page 2514 is the page associated with the third step of printing viz. This page explains the purpose and a overview on the contents of the instructions that he is going to print out. The instructions will provide the following details to the user:

1. Places the applicant should sign on the INS forms.

2. The supporting documents that needs to be sent with the INS application.

3. The INS fees to be included with user's application.

4. Photographs to be enclosed.

5. The proper order in which user will have to arrange the INS forms and your Supporting documents.

6. Helps identify the INS Office Location where the application needs to be sent.

This page has a print button that will enable the user to initiate the actual printing It contains a back button that take the user to 2512 and a continue that takes him to the thank you page 2516. The printing of the instructions is the last step of the user's application process. With the documents and the information provided to him, the user will now be in a position to compile his total application and submit it to the INS.

In the last page 2516 the user is congratulated on the successful completion of his application. From here he can continue again to the home page. Even though the user has completed his application successfully and exits the System, his entire application information has been saved securely in the System. The user has the option to come back, access and modify his application any time he wants. He will just have to sign-in from the System home page with the user ID and password provided to him during his registration in the System.

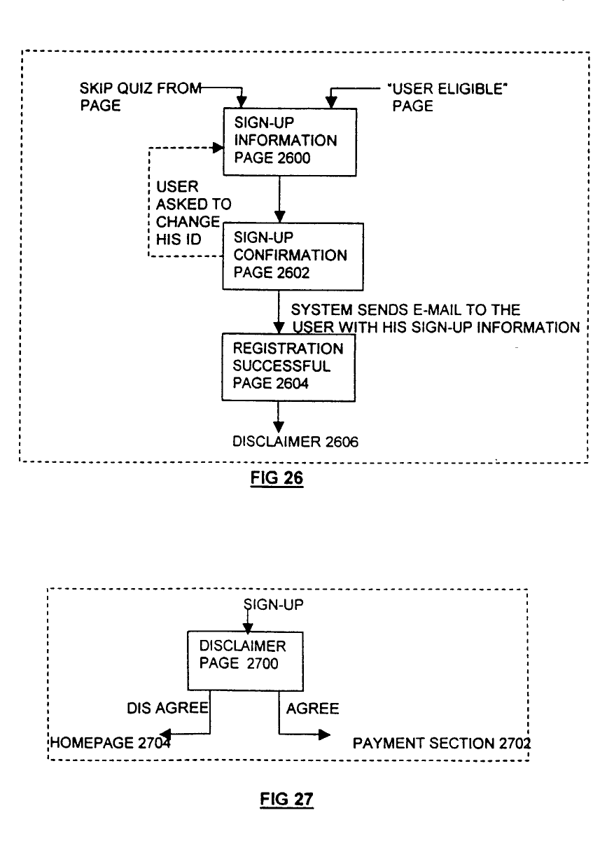

FIG. 26 is a flow chart of a preferred embodiment of the sign-up section module. Every user needs to sign-up before he is allowed to start any application in the System. The objective of the sign-up section is to create a unique identity for the user. In the sign-up section, the System will collect some basic information from the user. It will also enable him to choose a user ID and password using which he will be able to login any time from the home page. The information page 2600 will ask user for Name (first, last), email, User ID and Password.

In the next page 2602, the user views previously entered information for correctness. If the user ID already exists, user will be informed and again taken back to the information page 2600. If the user ID is valid, then the user is taken to the successful registration page. Transparent to the user, the System sends an e-mail to the user's e-mail ID about his log-in information.

In the last page 2604, the user is acknowledged that login ID has been successfully created with the requested password. From here the user is taken to the disclaimer section 2606.

FIG. 27 is a flow chart of a preferred embodiment of the disclaimer section module. This section has the disclaimer page 2700 which displays the System disclaimer. If the user is in agreement with the content, he is allowed to continue to pay-up 2702. If he is disagreement, he is brought back to the home page 2704.

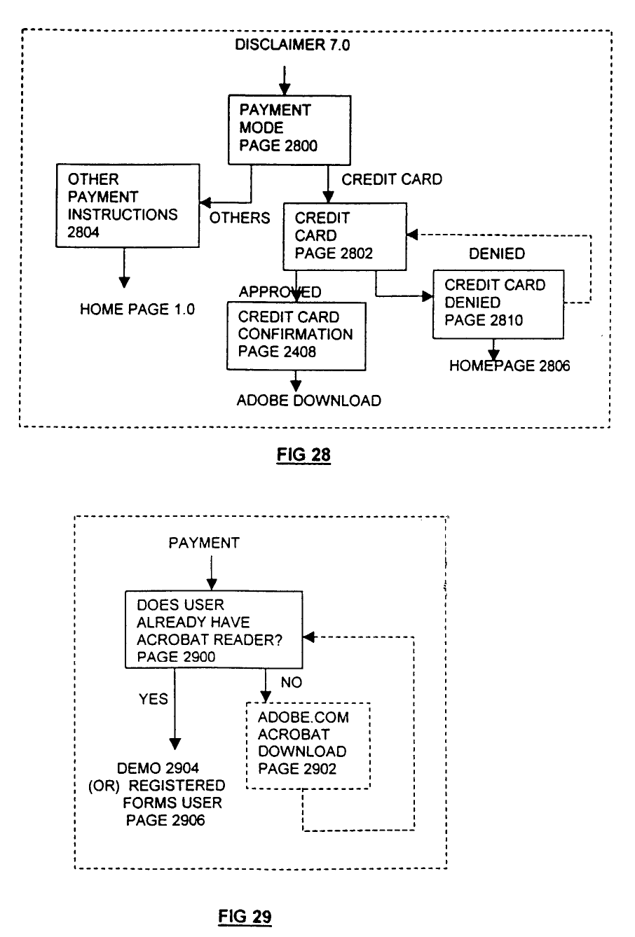

FIG. 28 is a flow chart of a preferred embodiment of the payment section module. This is the section where the user pays for his selected application in the System. The user is allowed multiple payment options, however, the online payment option is credit cards. Other forms of payment are: Western Union, American Express Travelers Cheques, Bank Transfers, U.S. Money Orders, International Money Order.

If the user uses the credit card mode of payment, he can seamlessly continue to start the his application process once his payment goes through successfully. For all other modes of payment, the user is given a brief description of how he can arrange his payment to be sent to the System administrators. He is informed that his account will be activated once the payment is received and the user can continue to the home page. The System will activate the user account for his use of the selected application within 48 hours of confirmation of the payment receipt.

The payment mode page 2800 displayed several payment options for the user, including: credit card, U.S. Money Order, International Money Order, Western Union, and American Express Travelers Cheques. If credit card is chosen, he is taken to the next page 2802. For all other modes of payment he is taken to a different page 2804.

If user doesn't use a credit card as a payment method, he/she will be brought to the payment instructions page 2804 where it will describe what the user needs to do next; based on the payment type he/she chose. From here the user can move forward to the homepage 2806 or back to the payment mode page 2800 and review his choice. When the user input all credit card information, he/she will be informed that credit card was approved 2408 or denied 2410. He can then continue to the simple questions section through the DEMO or to the homepage or trace back to payment.

FIG. 29 is a flow chart of a preferred embodiment of the Adobe Acrobat® (download module. The user is brought to this page 2900 immediately after sign-up. The System incorporates PDF, as the format for displaying the forms and other parts of the application. To successfully use the System, the user needs to have Adobe Acrobat® reader on his computer.

Adobe Acrobat® is software, or freeware, that is downloadable free of charge from the Adobe® corporate website. The purpose of this section to detect if the user's computer already has Adobe Acrobat® installed in it. If the computer has Acrobat, then the picture of an object pops up on the screen. The user is asked if he is able to see the object. If yes, the user continues to the next section. If no, the user is then coached though the process of downloading. Then the Adobe® download page 2902 in Adobe.com corporate website is displayed on a separate browser window. Once the user completes the download he closes this download browser window. If the download is successful and he is able to see the object now, he will proceed to the next section.

After the down load the user is taken to the demo section 2904 if he had signed up for the Do-It-Yourself services. If he has signed up for the INS official form, then he is taken to the registered users INS forms page 2906.

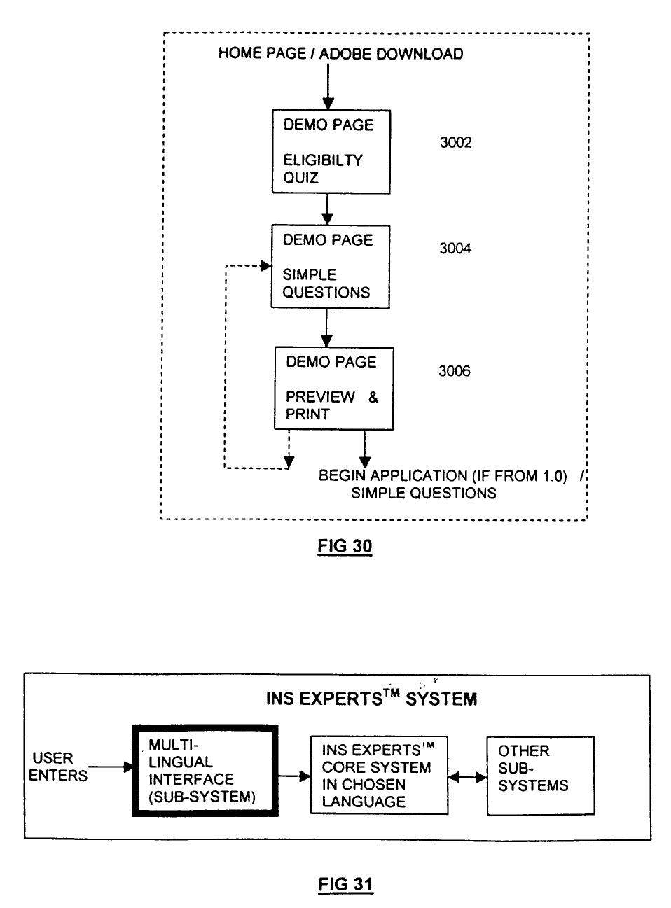

FIG. 30 is a flow chart of a preferred embodiment of the demo section module. This section gives the user a guided tour on the user interfaces the user will see in the important section in the site such as eligibility quiz, simple questions and preview. This will help him get used to the feel of the pages and understand the use of the various options provided on the page.

Currently this section contains a set of three pages. Each page contains a screen shots of pages the user will actually encounter in the respective sections. Call outs and other explanations explain the purpose and the functions in each screen shot.

Page 3002: Explains pages in the eligibility quiz section. Page 3004: Explains pages in the simple questions section. Page 3006: Explains pages how the user will use the preview.

This section can be accessed from the home page and at the end leads the user to the begin application page. Another way the user accesses this section is as part of the logical flow. Any user who has signed up is brought to this page. This will ensure that all users get an orientation before they actually start their application process by commencing simple questions.

FIG. 31 is a flow chart of a preferred embodiment of the multi-lingual interface (subsystem) of the present invention. This Section gives an overview of the various subsystems that encompass and support the Core System.

The user will be able to view all the content on the site in many non-English languages. If the user prefers not to view the content on the System website in English, user will choose from a list of many non-English languages in which to view the System or website. When user chooses a non-English language icon, all (exceptions where applicable) the pages that follow on the System will remain in the user chosen language.

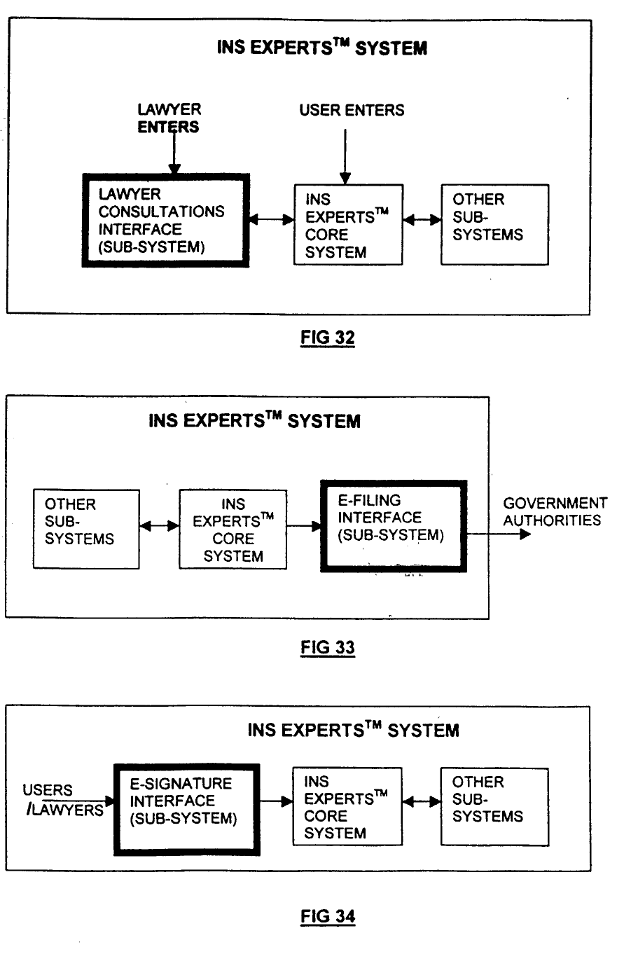

FIG. 32 is a flow chart of a preferred embodiment of the lawyer consultation interface (sub-system) of the present invention. After a user completes the eligibility section for an application in the Core system, the user will be allowed to receive an explanation or more detailed answers to their immigration and visa related questions from experienced immigration specialists. Users will submit their immigration related questions through the System secured environment and will have their own account folder (hereinafter “Secured Account Folder”), which is accessible only by the user and their specialist. A user ID and password will be given to the user which allows them access rights to their Secured Account Folder; here both the user and lawyer can send questions and receive answers.

Experienced immigration specialists will review your question, perform the necessary research, and respond to the users question. The user will receive an email stating that a response to their question or request has been posted in their System secured folder for review.

Lawyer Verification:

After users finish answering all the questions asked by the System interactive module, user will be given the option to get further verification on their application from an experienced immigration attorneys or professionals who are able to provide assistance on immigration related for both profit and non-profit organizations (hereinafter “Specialist”). Users will submit their completed application through INS Experts (TM) secured system, which is accessible only by the user and their Specialist. A user ID and password will be given to the user which allows them access rights to their secured folder; here both the user and Specialist can send questions and receive answers with regards to the users application.

Experienced immigration Specialists will review user's application, perform the necessary research, and make any comments or changes if necessary to the users application. The user will receive an email stating that a response to their application has been posted in their System secured folder for review.

To access the account information, the user would enter a User ID and password from the System homepage. The Secured Account Folder contains the status of the users application, the list of supporting documents for their application; a window to submit additional questions, and responses to previously submitted questions.

The Specialist will send instructions regarding necessary documents for application preparation through the Secured Account Folder. Documents will be requested “Supporting Documents” (example: Birth Certificate, Passport etc.), by the Specialist, which accompany and complete their application with the respective government agency(s), by the Specialist. The user may send the “Supporting Documents” via electronic means or by postal mail) to the Specialist. Once Specialist receives documents (either electronically or by postal mail), the information will be posted to the users or clients Secured Account Folder. The user's prepared application will be forwarded to them at the e mail or home address listed on the questionnaire for review and signature. Users may use electronic or digital signature technology to sign all documents and forms required in the application.

The user will then send (either electronically or via postal mail) their application and supporting documentation to the Specialist handling the case for review. If the Specialist determines the application is incomplete because documents do not comply or are missing, additional requests will be posted to their Secured Account Folder. The user will receive an email each time an additional request is posted to their Secured Account Folder.

The Specialist's document and application review may necessitate amending the application, including previously signed forms. In that case, the user will be notified and amended forms will be forwarded for signature (either electronically or via postal mail).

Upon determining the user application accuracy and completeness, the Specialist will file the application with the appropriate government agency. If a government agency requests additional documentation necessary to process user application, the Specialist will post a “Subsequent Documents Request” to their Secured Account Folder on the System. If after reviewing the subsequent documents, the Specialist determines a document does not comply or is missing, additional Subsequent Documents Requests will be posted to their Secured Account Folder. The user will receive an email each time a Subsequent Documents Request is posted to their Secured Account Folder.

When the Specialist receives a decision from the Agency, a summary of the decision and date will be posted on the user Secured Account Folder. They will receive an email advising that the posting has been made.

FIG. 33 is a flow chart of a preferred embodiment of the e-filing interface (sub-system) of the present invention. Here, the users will have the choice to electronically file their application through the system directly with the respective government agency.

In addition, the System Specialist, will also be allowed to e-file all applications for their clients through the System. The application is transmitted to the respective government agency. The government agency will then review application. The government agency may then communicate with the user directly or with the Specialist; requesting further Supporting Documentation. The Agency's communication can happen via e-mail or through postal mail.

Once application has been processed, the government agency will send all documents via electronic means or through postal mail to the original sender. All electronic communication would occur on the System.

FIG. 34 is a flow chart of a preferred embodiment of the e-signature interface (sub-system) of the present invention. This makes it possible to legally secure electronic signing of documents anywhere at any time. Included in this feature are multi-lingual handwriting recognition systems, dynamic signature verification, ink compression and operating system extensions that enable pen input. E-signature will enable all users, Specialists and Government agencies to sign all documents/forms electronically.

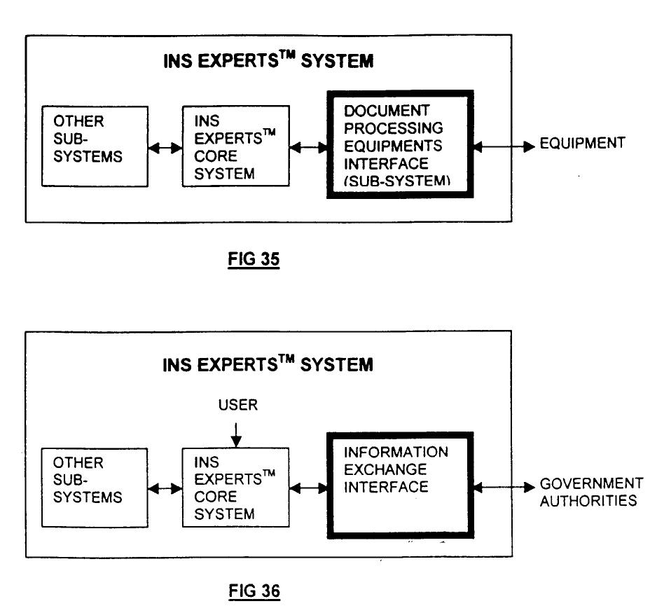

FIG. 35 is a flow chart of a preferred embodiment of the documents processing equipments interface (sub-system) of the present invention. This enables the users to use equipments such as scanners to scan and store their supporting documents for coordination and On-line filing.

Users will be able to scan all related documents, which are needed to complete the application process, and store it in their Secured Account Folder. Based on user's authorization, both the Specialist and/or government agencies will be able to review and print all scanned documents. In addition, both Specialists and Government Agencies will have the facility to upload scanned documents into a Secured Account Folder for users review.

FIG. 36 is a flow chart of a preferred embodiment of the information exchange interface (sub-system) of the present invention. The System will have an on-line interface with the immigration related government authorities to enable users to ask questions with regards to immigration or application issues. The government agencies will communicate with individuals and vice-versa via electronic means using the System.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A method for processing immigration applications and enabling users such as prospective or recent immigrants to start, manage, and complete the immigration and associated processes on-line, the method comprising the following steps:
electronically accessing an INS application and servicing center system over an electronic computer network;
entering preliminary screening and qualifying data particular to the user;
determining the eligibility of the user for initiating and completing any of the various INS procedures related to immigration and naturalization;
selecting any of the various INS forms which the user is required to fill out for initiating and completing the specific INS procedures related to immigration and naturalization which the user is eligible for;
entering the correct data required by the selected forms; and
electronically sending the completed forms to the particular agency according to the filing guidelines of the INS, whereby any of the various INS procedures related to immigration and naturalization for which the user is eligible can be initiated, performed in part or completed without making administrative errors.

2. The method of claim 1, further comprising the following step:
printing out the completed forms which need to be signed and transferred back to the INS.

3. The method of claim 1, further comprising the following step:
making electronic payments for any required filing fees or costs.

4. The method of claim 1 in which the step of electronically accessing an INS application and servicing center system over an electronic computer network includes logging onto the homepage of website accessible over the internet.

5. The method of claim 1 in which the step of electronically accessing an INS application and servicing center system over an electronic computer network is accomplished by a user through the use of a personal computer.

6. The method of claim 1, further comprising the following step:
providing the user with a set of detailed instructions for initiating, performing in part or completing any of the various INS procedures related to immigration and naturalization for which the user is eligible.

7. The method of claim 1 in which the step of determining the eligibility of the user for initiating and completing any of the various INS procedures related to immigration and naturalization comprises a comparison of the preliminary screening and qualifying data particular to the user to standards, rules and regulations followed by the INS.

8. The method of claim 8 in which the step of entering preliminary screening and qualifying data particular to the user creates a user log containing the preliminary screening and qualifying data particular to the user.
